(19) United States
(12) Patent Application Publication
(10) Pub. No.: US 2024/0031826 A1
(43) Pub. Date: Jan. 25, 2024

(54) METHODS, APPARATUS AND SYSTEMS FOR DETERMINING BEAM INFORMATION ACROSS COMPONENT CARRIERS

(71) Applicant: ZTE CORPORATION, Shenzhen (CN)

(72) Inventors: Zhen HE, Shenzhen (CN); Bo GAO, Shenzhen (CN); Ke YAO, Shenzhen (CN); Shujuan ZHANG, Shenzhen (CN); Chuangxin JIANG, Shenzhen (CN); Zhaohua LU, Shenzhen (CN)

(73) Assignee: ZTE CORPORATION, Shenzhen, Guangdong (CN)

(21) Appl. No.: 18/241,026

(22) Filed: Aug. 31, 2023

Related U.S. Application Data
(63) Continuation of application No. PCT/CN2021/084345, filed on Mar. 31, 2021.

(51) Int. Cl. H04W 16/28; H04B 7/06

(52) U.S. Cl. CPC H04W 16/28; H04B 7/06968

(57) ABSTRACT

Systems, methods and devices for determining beam information across component carriers can include a wireless communication device determining that a defined condition is met. The wireless communication device may receive, from the wireless communication node, control information. The wireless communication device may determine, responsive to the defined condition being met, a beam state to be applied to a signal in a first component carrier (CC) according to a beam state pool in a second CC. The wireless communication device may communicate the signal according to information associated with the beam state.

### CROSS-REFERENCE TO RELATED APPLICATION

This application claims the benefit of priority under 35 U.S.C. § 120 as a continuation of PCT Patent Application No. PCT/CN2021/084345, filed on Mar. 31, 2021, the disclosure of which is incorporated herein by reference in its entirety.

### TECHNICAL FIELD

The disclosure relates generally to wireless communications, including but not limited to methods, devices and systems for determining beam information across component carriers.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

At least one aspect is directed to a system, method, apparatus, or a computer-readable medium. A wireless communication device may determine that a defined condition is met. The wireless communication device may receive, from the wireless communication node, control information. The wireless communication device may determine, responsive to the defined condition being met, a beam state to be applied to a signal in a first component carrier (CC) according to a beam state pool in a second CC. The wireless communication device may communicate the signal according to information associated with the beam state.

In some embodiments, the information associated with the beam state may include at least one of a quasi-co location (QCL) assumption, a spatial relation, or a power control (PC) parameter. The QCL assumption may include a first QCL type and a second QCL type. The first QCL type may include at least one of QCL TypeA, QCL TypeB or QCL TypeC. The second QCL type may include at least QCL TypeD. A reference signal (RS) of the first QCL type may be located in the first CC and may be indicated by a RS resource identifier (ID) in the beam state. A RS of the second QCL type may be located in the first CC or the second CC and may be indicated by a RS resource ID in the beam state. The RS of the first QCL type may be quasi co-located with the RS of the second QCL type.

The signal may comprise at least one of a physical downlink shared channel (PDSCH), a physical downlink control (PDCCH), a physical uplink shared channel (PUSCH), a physical uplink control channel (PUCCH), a PUCCH group, a channel state information reference signal (CSI-RS), or a sounding reference signal (SRS).

In some embodiments, the wireless communication device may receive, from a wireless communication node in the first CC, downlink control information (DCI) including a transmission configuration indicator (TCI) field that indicates an activated beam state in the second CC. In some embodiments, the wireless communication device may receive, from a wireless communication node, a control signaling that indicates an index of the second CC. The control signaling may comprise at least one of a radio access control (RRC) signaling, a medium access control control element (MAC CE) signaling, or a downlink control information (DCI) signaling. The wireless communication device may determine the second CC according to the index of the second CC.

In some embodiments, the wireless communication device may receive, from a wireless communication node, a control signaling that indicates at least one of an index of the first CC or an index of a CC group including the first CC. The control signaling may comprise at least one of a radio access control (RRC) signaling, a medium access control control element (MAC CE) signaling, or a downlink control information (DCI) signaling. The wireless communication device may determine the first CC according to the index of the first CC or the index of the CC group including the first CC.

In some embodiments, the second CC and the first CC may belong to a same CC group. The wireless communication device may determine, from the CC group, a CC with a configured beam state pool, as the second CC. The wireless communication device may determine, from the CC group, a CC that is a primary cell (PCell), as the second CC. The wireless communication device may determine, from the CC group, a CC with a lowest CC index or a highest CC index, as the second CC.

In some embodiments, determining that the defined condition is met may comprise determining that the wireless communication device is not provided or configured with a beam state pool in the first CC. Determining that the defined condition is met may comprise the wireless communication device determining that a beam state identifier (ID) configured by a radio resource control (RRC) signaling for the beam state applied to the signal, is not defined in a beam state pool in the first CC. A type of the signal may include at least one of periodic or aperiodic.

In some embodiments, determining that the defined condition is met may comprise the wireless communication device determining that a beam state identifier (ID), activated by a medium access control control element (MAC CE) signaling for the beam state to be applied to the signal, is not defined in a beam state pool in the first CC. A type of the signal may include at least one of semi-persistent or aperiodic.

In some embodiments, determining that the defined condition is met may comprise the wireless communication device receiving, via radio resource control (RRC) signaling, a parameter to enable the wireless communication device to determine the beam state to be applied to the signal in the first CC according to the beam state pool in the second CC. The signal may include a downlink (DL) signal, and the beam state pool may be applied to the DL signal. The signal may include an uplink (UL) signal, and the beam state pool may be applied to the UL signal. The parameter may indicate at least an index of the second CC. If the wireless communication device is provided with the parameter, the wireless communication device may not expect that the wireless communication device is provided or configured with a beam state pool in the first CC.

In some embodiments, determining that the defined condition is met may comprise the wireless communication device receiving, via a signaling, a parameter to set the wireless communication device to operate in a mode 2. In a mode 1, the wireless communication device is to determine the beam state to be applied to the signal in the first CC according to a beam state pool in the first CC. In the mode 2, the wireless communication device is to determine the beam state to be applied to the signal in the first CC according to the beam state pool in the second CC. The parameter may include at least an index of the second CC. If the wireless communication device receives a parameter to set the wireless communication device to operate in the mode 2, no beam state pool may be expected to be configured in the first CC. The beam state pool may comprise a beam state pool applied to a physical downlink shared channel (PDSCH).

At least one aspect is directed to a system, method, apparatus, or a computer-readable medium. The wireless communication node may communicate, with a wireless communication device, a signal in a first component carrier (CC) according to information associated with a beam state. A defined condition may be determined to be met by a wireless communication device, and responsive to the defined condition being met, the beam state may be determined according to a beam state pool in a second CC.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 shows a flowchart illustrating a method for configuring a reference signal, in accordance with some embodiments of the present disclosure;

FIG. 4 shows a diagram illustrating a first example of two beam state pools associated with two component carriers, respectively, in accordance with some embodiments of the present disclosure;

FIG. 5 shows a diagram depicting an example of updating of beam state information using a radio resource control (RRC) signaling, in accordance with some embodiments of the present disclosure;

FIG. 6 shows a diagram depicting an example of updating of beam state information using MAC-CE signaling, in accordance with some embodiments of the present disclosure;

FIG. 7 shows a diagram depicting another example of updating of beam state information using RRC signaling, in accordance with some embodiments of the present disclosure; and

FIG. 8 shows a diagram depicting another example of updating of beam state information using MAC-CE signaling, in accordance with some embodiments of the present disclosure.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

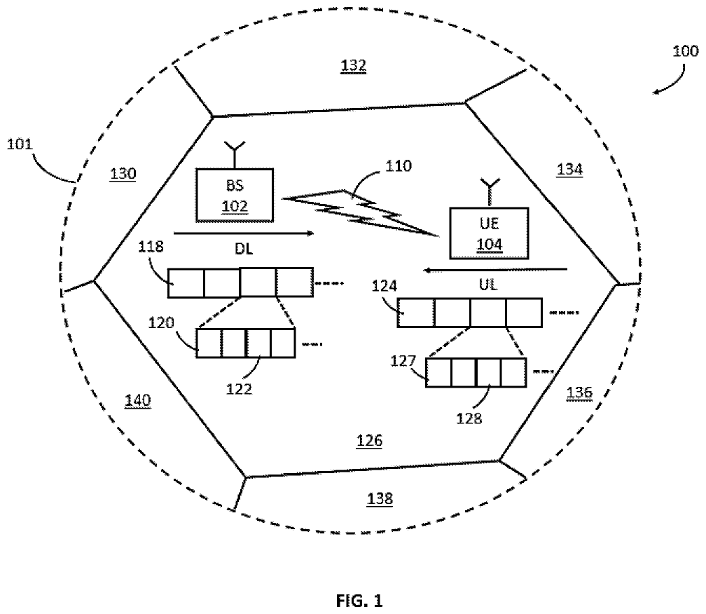

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127, which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

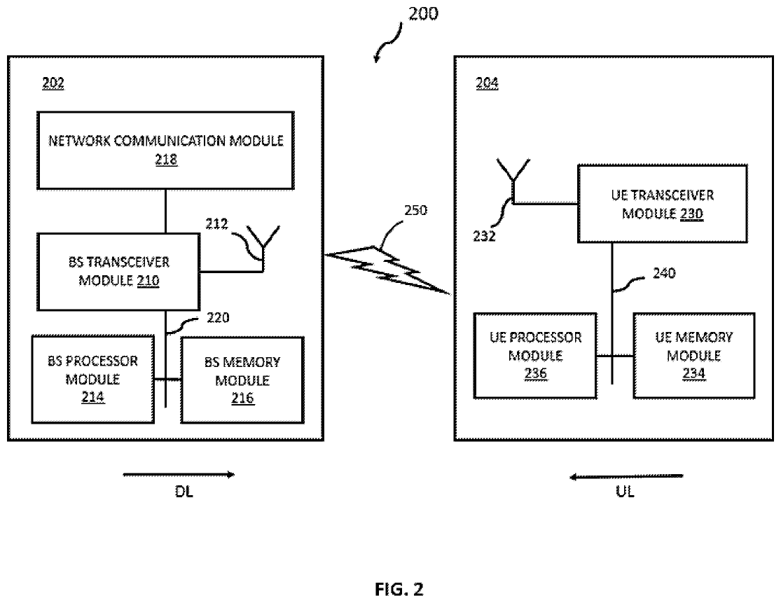

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Control Channel Monitoring

In 5G new radio (NR), the analog beam-forming is introduced into mobile communication for guaranteeing the robustness of high frequency communications (FR2). Specifically, the wireless communication device 104 or 204, also referred to herein as user equipment (UE), can be configured with a received (Rx) beam or transmitted (Tx) beam by the wireless communication node 102 or 202, also referred to herein as base station (gNB), or the network (NW) to receive downlink (DL) channel and signal or transmit uplink (UL) channel and signal directionally. Furthermore, the beam information is provided by a transmission configuration indicator (TCI) state, which is configured, activated or indicated by the wireless communication node 102 or 202. Due to the change of environment and the movement or rotation of the wireless communication device 104 or 204, the Rx/Tx beam needs to be constantly updated to match the channel between the wireless communication device 104 or 204 and the wireless communication node 102 or 202.

In order to update (or indicate) the beam of a channel or signal, e.g., physical downlink shared channel (PDSCH), the wireless communication node 102 or 202 uses a radio resource control (RRC) signaling to configure a list (or pool) of up to 128 TCI states in a given cell serving the wireless communication device 104 or 204 (referred to herein as serving cell). Then, the wireless communication device 104 or 204 is provided with a set of beam state(s) (or TCI state(s)) that are activated by a medium access control control element (MAC-CE) signaling from the list of TCI states. Finally, the wireless communication device 104 or 204 can be provided an indication of a beam state (or TCI state) by a downlink control information (DCI) signaling.

In a carrier aggregation (CA) scenario, multiple component carriers (CCs) can serve the same wireless communication device 104 or 204. Generally, the beam update of each CC can be done independently. However, since these CCs may be in the same frequency band, the wireless communication device 104 or 204 may be provided with an indication of the same beam applied to these CCs. On the other hand, considering that the signaling overhead of configuring multiple beam state pools (or TCI state pools) in multiple CCs is large, it has been agreed that the wireless communication device 104 or 204 can be configured (or updated) with only one beam state pool (or one TCI state pool) in one CC and the configured (or updated) beam state pool can also be applicable to the other CCs. However, this may cause some technical problems. For instance, in order to update the beams of CC-1 and CC-2 simultaneously, a new beam state pool is configured in CC-1 by RRC signaling. But for CC-2, the old beam state pool configured in CC-2 is still applicable. In this case, how to use these two beam state pools reasonably, and specifically, under what conditions or circumstances are these two beam state pools applied. So far, there is no effective way to solve this problem. This current disclosure provides an effective method for obtaining beam state across CCs to solve this technical problem effectively.

As used herein, a beam state may be is equivalent to, or comprises, at least one of a quasi-co-location (QCL) state, QCL assumption, reference signal (RS), transmission configuration indicator (TCI) state, spatial relation information (spatialRelationInfo), or power control (PC) information. In the embodiments described herein, the TCI state is used as an illustrative example and should not be interpreted as limiting.

A “QCL” or “QCL assumption” may include at least one of Doppler spread, Doppler shift, delay spread, average delay, average gain and/or spatial parameter. A TCI state may include one or more reference RS, also referred to herein as QCL RSs, and their corresponding QCL type parameters. The QCL type parameters may include at least one of Doppler spread, Doppler shift, delay spread, average delay, average gain and/or spatial filter or spatial parameter. For example, QCL type may include “QCL-TypeD,” which is used to represent the same or quasi-co spatial filter between targeted RS or channel and the one or more reference QCL-TypeD RSs. A spatial filter can also be called beam. A TCI state pool can include a list of TCI states and corresponding indices (or TCI state IDs).

As used herein, spatial relation information (spatialRelationInfo) may include one or more reference RSs (also called spatial RSs) used to represent the same or quasi-co “spatial relation” between targeted “RS or channel” and the one or more reference RSs. The spatial relation can also be called beam.

As used herein, PC information may include at least one of pathloss (PL), open loop configuration and closed loop configuration. Specifically, “PL” can be calculated by using a PL reference signal (RS), e.g., periodic CSI-RS or SSB. As used herein, open loop configuration may include at least one of p0 and/or alpha. Specifically, “p0” refers to target receive power, and alpha refers to compensation coefficient of PL. A closed loop configuration, as used herein, refers to closed loop power adjustment (state), and is referred to as “closed loop” for short.

As used herein, a component carrier (CC) can be equivalent to a serving cell or a bandwidth part (BWP) of the CC. A CC group can be equivalent to a group including one or more CC(s), and it can be configured by a higher layer configuration (e.g., RRC signaling). A PUCCH group can be equivalent to a group including one or more PUCCH resource(s), and it can be configured by a higher layer configuration (e.g., RRC signaling). As used herein, a PDCCH can be equivalent to a control resource set (CORESET).

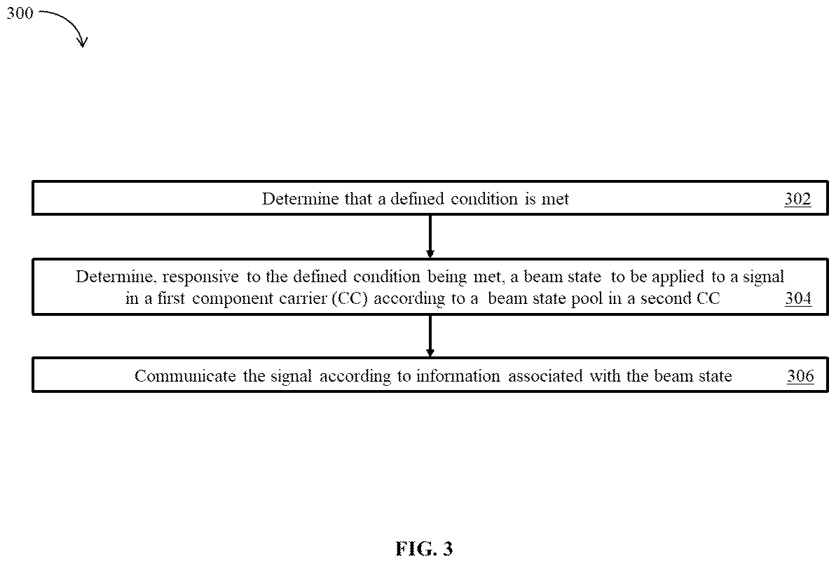

Referring to FIG. 3, a flowchart illustrating a method 300 for determining beam information across component carriers is shown, in accordance with some embodiments of the present disclosure. The method 300 can include the wireless communication device 104 or 204 determining that a defined condition is met (STEP 302). The method 300 can include the wireless communication device 104 or 204 determining, responsive to the defined condition being met, a beam state to be applied to a signal in first CC according to a beam state pool in a second CC (STEP 304). The method 300 can include the wireless communication device 104 or 204 communicating the signal according to information associated with the beam state (STEP 306).

The method 300 is performed by the wireless communication device 104 or 204. From the perspective of the wireless communication node 102 or 202, the wireless communication node 102 or 202 may communicate (e.g., receive or transmit), with a wireless communication device, a signal in a first component carrier (CC) according to information associated with a beam state. A defined condition may be determined to be met by a wireless communication device, and responsive to the defined condition being met, the beam state may be determined according to a beam state pool in a second CC.

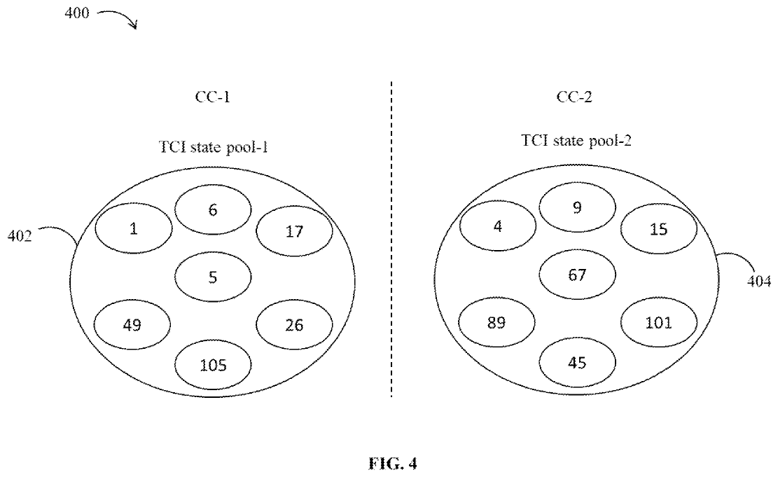

Referring to FIG. 4, a diagram 400 illustrating a first example of two beam state pools associated with two component carriers, respectively, is shown, in accordance with some embodiments of the present disclosure. Diagram 400 depicts an example CA scenario where both CC-1 and CC-2 serve the wireless communication device 104 or 204 together. In the following, CC-1 is referred to as a second CC and CC-2 is referred to as a first CC. In this scenario, CC-2 is the serving cell of the wireless communication device 104 or 204. As shown in FIG. 4, diagram 400 includes two TCI state pools, or more generally two beam state pools, in CC-1 and CC2, respectively. Specifically, TCI state pool-1 402 (also referred to herein as second TCI state pool 402) is in CC-1, and TCI state pool-2 404 (also referred to herein as first TCI state pool 404) is in CC-2. The numbered cells in each TCI state pool (or each beam state pool) represent the TCI states or beam states in that pool. The number on each cell represents the index of the corresponding TCI state (or beam state), referred to herein as TCI state ID or beam state ID. For instance, the numbers 1, 5, 6, 17, 26, 49 and 105 represent TCI state IDs of TCI states in TCI state pool-1 402, and the numbers 4, 9, 15, 45, 67, 89 and 101 represent TCI state IDs of TCI states in TCI state pool-2 404.

In order to update the beam information of DL/UL channel or signal in CC-1 and CC-2 simultaneously, e.g., beam information of PDSCH/PDSCH/CSI-RS, PUSCH/PUCCH/SRS in CC-1 and CC-2, the wireless communication node 102 or 202 may use a RRC signaling to reconfigure TCI state pool 402 in CC-1. As stated above, CC-1 is not the serving cell of the wireless communication device 104 or 204. It is assumed that the wireless communication device 104 or 204 have been configured with first TCI state pool (or TCI state pool-2) 404 in CC-2, and TCI state pool-2 404 is used to provide beam information of PDSCH, PDCCH, CSI-RS, PUSCH, PUCCH, and (or) SRS in CC-2. Second TCI state pool (or TCI state pool-1) 402 is a new TCI state pool reconfigured for use by the wireless communication device 104 or 204 in CC-1. In this case, the wireless communication device 104 or 204 may have contradictions. Specifically, the wireless communication device 104 or 204 does not know under what conditions to use the new reconfigured TCI state pool or TCI state pool-1 402.

Method 300 allows for obtaining TCI state(s) across CCs to solve the problem described above effectively. Specifically, method 300 can include the wireless communication device 104 or 204 checking/determining whether a predefined or triggering condition is met (STEP 302). Responsive to determining that the predefined/triggering condition is met, the wireless communication device 104 or 204 can determine a TCI state, or more generally, a beam state, to be applied for a signal in a serving CC, e.g., CC-2, according to a TCI state pool (or a beam state pool) in a reference CC, e.g., CC-1 (STEP 304). In other words, the wireless communication device 104 or 204 can apply the TCI state pool in the reference CC not only to the reference CC, but also to the serving CC. Furthermore, the wireless communication device 104 or 204 can apply the TCI state determined according to (or from) the TCI state pool in the reference CC is not only to the reference CC, but also to the serving CC.

The wireless communication device 104 or 204 can determine information associated with the beam state (or TCI state). The first information can include at least one of a QCL assumption, a spatial relation and/or a PC parameter. The wireless communication device 104 or 204 can communicate the signal with the wireless communication node 102 or 202 according to the information associated with the beam state or TCI state (STEP 306). For example, the wireless communication device 104 or 204 can receive the signal (e.g., PDSCH) according to the QCL assumption. According to another example, the wireless communication device 104 or 204 can transmit the signal (e.g., PUSCH), e.g., to the wireless communication node 102 or 202, according to the spatial relation and (or) the PC parameter.

The signal can include at least one of PDSCH, PDCCH, PUSCH, PUCCH, PUCCH group, CSI-RS and/or SRS. The TCI state pool can refer to a TCI state pool applied to (or used for) PDSCH. Specifically, the TCI state pool can be a TCI state pool applied to indicate beam information of PDSCH, and it may be configured in PDSCH-Config. A TCI field in DCI in the serving CC can point to the activated TCI state in the reference CC.

The wireless communication node 102 or 202 can indicate, or provide an indication of, the reference CC (e.g., CC-1) to the wireless communication device 104 or 204 using a control signaling. The control signaling can include at least one of a RRC signaling, a MAC-CE signaling and a DCI. For instance, the wireless communication node 102 or 202 may provide the wireless communication device 104 or 204 the index of the reference CC via a RRC signaling. Alternatively, the wireless communication node 102 or 202 may provide the wireless communication device 104 or 204 the index of the reference CC using an activation command (MAC-CE signaling) or a DCI. For example, a CC indicator field in DCI can be used to indicate the index of the reference CC.

The serving CC can be signaled/indicated to the wireless communication device 104 or 204 using a control signaling. The control signaling can include at least one of a RRC signaling, a MAC-CE signaling and/or a DCI. Specifically, the wireless communication node 102 or 202 can provide/send the index (or multiple indices) of the serving CC to the wireless communication device 104 or 204 using a RRC signaling. The wireless communication node 102 or 202 can provide/send the index (or multiple indices) of the serving CC to the wireless communication device 104 or 204 using an activation command (MAC-CE signaling) or a DCI. In some implementations, the wireless communication node 102 or 202 can provide/send an index of a CC group to the wireless communication device 104 or 204 using the control signaling. The CC group can include the serving CC. A CC group including the reference CC may be different from a CC group including the serving CC. For example, the two CC groups can be located in FR1 (low frequency) and FR2 (high frequency) respectively, or they can be located in different frequency bands.

In some implementations, the reference CC and the serving CC may belong to the same CC group as the beams of these two CCs are likely to be updated simultaneously in this case. The wireless communication device 104 or 204 can determine that the reference CC is the CC with the lowest or highest index (e.g., cell index) in the CC group. The reference CC can be the CC that is configured with a TCI state pool in the CC group.

The predefined condition can include at least one of a plurality of conditions. A first condition can be that the wireless communication device 104 or 204 is not provided with a TCI state pool in the serving CC. For example, for CC-2, if the wireless communication device 104 or 204 is not configured with a TCI state pool (e.g., TCI state pool-2 404) in CC-2, the wireless communication device 104 or 204 can determine (or obtain or find) a TCI state in TCI state pool-1 402 configured in CC-1. A second condition can be that TCI state ID(s) configured by a RRC signaling for the signal may not be defined/found in a TCI state pool in the serving CC. A TCI state ID is not defined in a TCI state pool configured in a serving CC means that, there is no TCI state corresponding to the TCI state ID in the TCI state pool in the serving CC. See Example-1 and Example-3 below. The type of the signal may be periodic (P) or aperiodic (AP), such as periodic channel state information reference signal (CSI-RS), an aperiodic CSI-RS or a periodic sounding reference signal (SRS).

A third condition may be that TCI state ID(s) activated by a MAC-CE signaling for the signal is not defined in a TCI state pool configured in the serving CC. See Example-2 and Example-4 below. The type of the signal may be semi-persistent (SP) or aperiodic, such as a semi-persistent CSI-RS, semi-persistent SRS, and aperiodic SRS.

A fourth condition may be that the wireless communication device 104 or 204 is provided with a first parameter that is configured by a RRC signaling and is used to enable the wireless communication device 104 or 204 to determine a TCI state applied for a signal in a serving CC according to a TCI state pool in a reference CC. See Example-5 below. The first parameter can include at least an index of the reference CC. If the wireless communication device 104 or 204 is provided with the parameter, the wireless communication device 104 or 204 may not expect that a TCI state pool is configured in the serving cell.

There can be two modes (e.g., Mode-1 and Mode-2) for determine the TCI state (or beam state) to be applied for the signal in the serving CC. For instance, according to Mode-1, the TCI state to be applied for the signal in the serving CC can be determined according to a TCI state pool in the serving CC. According to Mode-2, the TCI state to be applied for the signal in the serving CC can be determined according to a TCI state pool in the reference CC. In other words, Mode-1 and Mode-2 can be two different working modes, characteristics or functions. See Example-6 below. If the wireless communication device 104 or 204 is provided with a second parameter (e.g., by RRC signaling) indicative of Mode-1, the function corresponding to Mode-1 (for determining the TCI state) can applied to the wireless communication device 104 or 204. If the wireless communication device 104 or 204 is provided with a second parameter that is indicative of Mode-2, the function corresponding to Mode-2 can be applied to/by the wireless communication device 104 or 204. Specifically, a RRC parameter can be introduced for determining whether Mode-1 or Mode-2 is to be applied. For instance, when the RRC parameter is set to mode-1, the above mode-1 function can be applied, otherwise, the above mode-2 can be applied. The second parameter can include at least an index of the reference CC. If the wireless communication device 104 or 204 is provided with a second parameter that is indicative of Mode-2 (Mode-2 is to be applied to the wireless communication device 104 or 204), the wireless communication device 104 or 204 may not expect that a TCI state pool is configured in the serving cell.

In some implementations, supporting the determining of the TCI state to be applied for the signal in the serving CC according to the TCI state pool in the reference CC, or the support of Mode-1 and/or Mode-2 may depend on the signaling of the UE capability. For example, the wireless communication device 104 or 204 may need to report UE capability information to the wireless communication node 102 or 202 to inform the wireless communication node 102 or 202 that the wireless communication device 104 or 204 supports Mode-1 and Mode-2 or the determining of the TCI state to be applied for the signal in the serving CC according to the TCI state pool in the reference CC.

In some implementations, the QCL assumption can include at least one of a first QCL Type and a second QCL Type. The first QCL Type can include at least one of TypeA, TypeB, and Type C. The second QCL Type can include at least TypeD. A RS of the first QCL Type can be QCLed with a RS of the second QCL Type. In other words, the beam of the RS of the first QCL Type can be the same as the beam of the RS of the second QCL Type. For example, the beam of QCL-TypeA RS can be the same as the beam of QCL-TypeD RS. See Example-7 and Example-8 below.

### Example 1

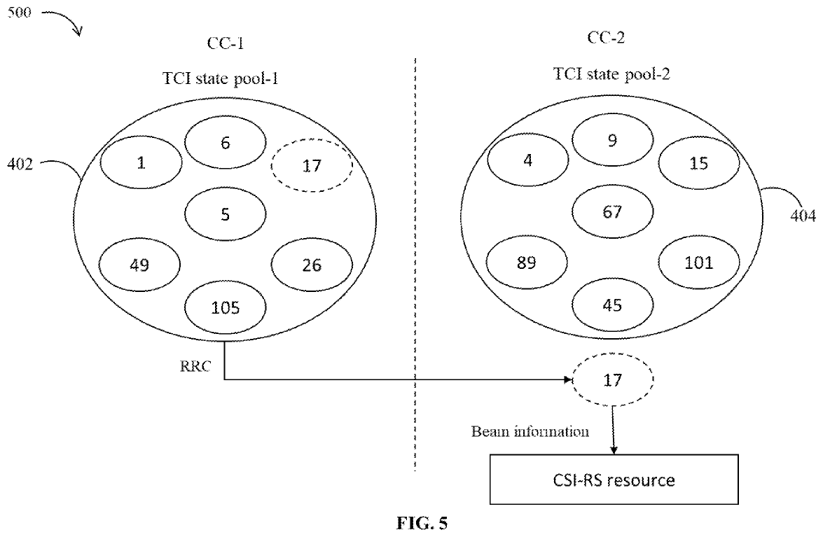

Referring to FIG. 5, a diagram 500 depicting an example of updating of beam state information using a radio resource control (RRC) signaling is shown, in accordance with some embodiments of the present disclosure. The TCI state pool-1 402 configured in CC-1 can be an updated TCI state pool that can be used in, or applied to, CC-1 and CC-2. That is, TCI state pool-1 402 can be a “new” TCI state pool, and CC-1 can be used as a reference CC. TCI state pool-2 404 configured in CC-2 can be an “old” (or previously configured) TCI state pool that can only be used in or applied to CC-2. These assumptions are also applicable to Example 2 through Example 7 below.

At a given time instant, in order to update the beam information of a CSI-RS (e.g., periodic CSI-RS or aperiodic CSI-RS) resource in CC-2, the wireless communication node 102 or 202 can use a RRC signaling to configure/reconfigure a TCI state (e.g., TCI state with TCI state ID=17) for the CSI-RS resource. For instance, for periodic CSI-RS, the TCI state ID can be configured in a higher layer parameter qcl-InfoPeriodicCSI-RS. For aperiodic CSI-RS, the TCI state ID can be configured in a higher layer parameter CSI-AperiodicTriggerState. Because the configured TCI state ID=17 is not defined in TCI state pool-2, the wireless communication device 104 or 204 can find the TCI state corresponding to the configured TCI state ID=17 in TCI state pool-1 in CC-1 402. The determined TCI state can provide beam information for the CSI-RS resource in CC-1. This example is also applicable to periodic SRS.

### Example 2

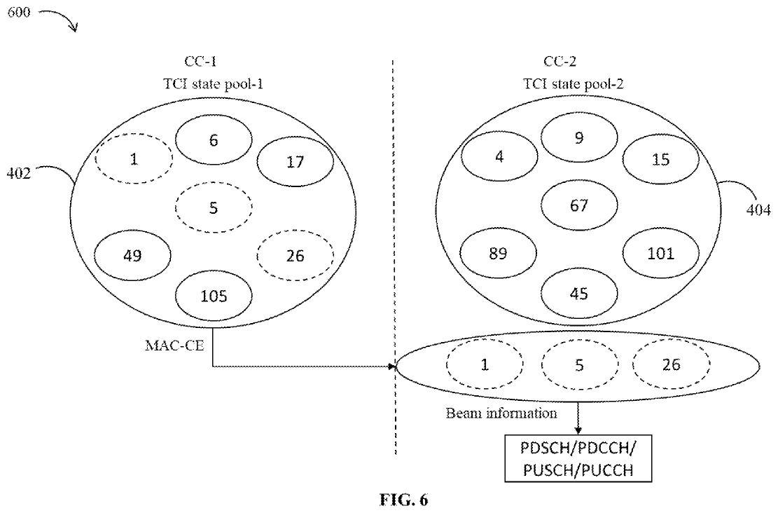

Referring to FIG. 6, a diagram 600 depicting an example of updating of beam state information using MAC-CE signaling is shown, in accordance with some embodiments of the present disclosure. At a given time instant, in order to update the beam information of a data and/or control channel (e.g., PDSCH, PDCCH, PUSCH, PUCCH) in CC-2, the wireless communication node 102 or 202 can use a MAC-CE signaling to activate a set of TCI state IDs (e.g., TCI state IDs 1, 5 and 26) for the channel. The activated TCI state ID=1, 5, 26 are not defined in TCI state pool-2 404. So, in this case, when the wireless communication device 104 or 204 receives the MAC-CE signaling, the wireless communication node 102 or 202 can find the TCI states corresponding to the activated TCI state IDs 1, 5 and 26 in TCI state pool-1 402 in CC-1. The determined TCI state can provide/include beam information for the data and/or control channel in CC-1. This example can also be applicable to PUCCH group, semi-persistent CSI-RS, semi-persistent SRS and aperiodic SRS.

### Example 3

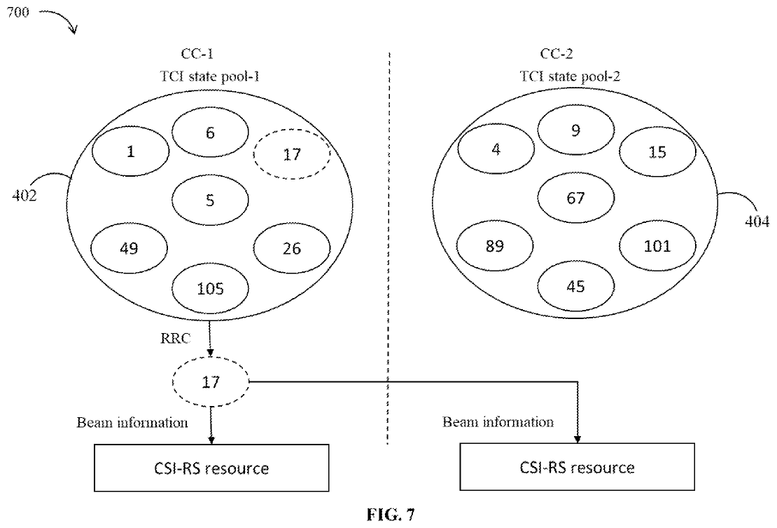

Referring to FIG. 7, a diagram 700 depicting another example of updating of beam state information using RRC signaling is shown, in accordance with some embodiments of the present disclosure. Assume that CC-1 and CC-2 belong to the same CC group. In order to update the beam information of a CSI-RS (e.g., periodic CSI-RS or aperiodic CSI-RS) resource in CC-1 and CC-2 simultaneously, the wireless communication node 102 or 202 can use a RRC signaling (that is in CC-1) to configure a TCI state (e.g., TCI state ID=17) for the CSI-RS resource. The TCI state ID can be applied to CC-1 and CC-2 simultaneously. The RRC signaling may also indicate a CC index pointing to CC-1, which is used to indicate that CC-1 is used as a reference CC. When the wireless communication device 104 or 204 receives the RRC signaling, for CC-1, the wireless communication device 104 or 204 can easily find the TCI state corresponding to the configured TCI state ID=17 in TCI state pool-1 402. For CC-2, because the configured TCI state ID=17 is not defined in TCI state pool-2, the wireless communication device 104 or 204 can find the TCI state corresponding to the configured TCI state ID=17 in TCI state pool-1 402 in CC-1. The determined TCI state can provide/include beam information for the CSI-RS resource in CC-1 and CC-2. This example can also be applicable to periodic SRS.

### Example 4

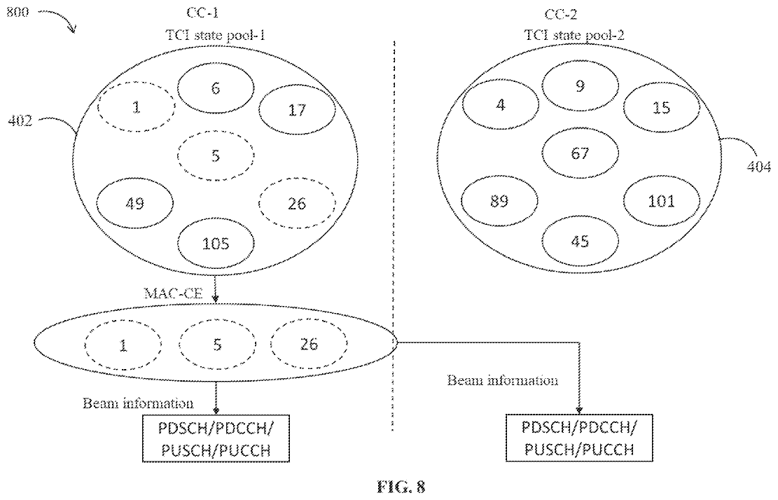

Referring to FIG. 8, a diagram 800 depicting another example of updating of beam state information using MAC-CE signaling is shown, in accordance with some embodiments of the present disclosure. Assume that CC-1 and CC-2 belong to the same CC group. In order to update the beam information of a data and/or control channel (e.g., PDSCH, PDCCH, PUSCH, PUCCH) in CC-1 and CC-2 simultaneously, the wireless communication node 102 or 202 can use a MAC-CE signaling to activate a set of TCI state IDs (e.g., TCI state ID=1, 5, 26) for the channel. This set of TCI state IDs 1, 5 and 26 can be applied to CC-1 and CC-2 simultaneously. The MAC-CE signaling may also indicate a CC index pointing to CC-1, which is used to indicate that CC-1 is used as a reference CC. When the wireless communication device 104 or 204 receives the MAC-CE signaling, for CC-1, the wireless communication device 104 or 204 can easily find the TCI states corresponding to the activated TCI state IDs 1, 5 and 26 in TCI state pool-1 402. For CC-2, because the activated TCI state IDs 1, 5 and 26 may not be defined in TCI state pool-2 404, the wireless communication device 104 or 204 can find the TCI state corresponding the activated TCI state IDs 1, 5 and 26 in TCI state pool-1 402 in CC-1. The activated TCI states can provide beam information for the data and/or control channel in CC-1 and CC-2. This example can also be applicable to PUCCH group, semi-persistent CSI-RS, semi-persistent SRS and aperiodic SRS.

### Example 5

According to another example, and at a given time instant, the wireless communication device 104 or 204 can be provided with a first parameter (e.g., higher layer parameter) by a RRC signaling. The first parameter can be used to enable the wireless communication device 104 or 204 to determine a TCI state applied for a signal in a serving CC (e.g., CC-2) according to a TCI state pool in a reference CC (e.g., TCI state pool-1 402 in CC-1). If the wireless communication device 104 or 204 receives a RRC signaling or MAC-CE signaling that is to update the beam (e.g., Example-1 through Example-4) for CC-2, the wireless communication device 104 or 204 can only find the TCI state corresponding to the configured or activated TCI state IDs in TCI state pool-1 402 in CC-1, regardless of whether there is a TCI state pool in CC-2 and/or whether the configured or activated TCI state IDs are defined in the TCI state pool-2 404 (if it exists) in CC-2.

### Example 6

According to yet another example, and at a given time instant, the wireless communication device 104 or 204 can be provided with a second parameter (e.g., higher layer parameter) by a RRC signaling. The second parameter can be set to Mode-1 and/or Mode-2. Mode-1 can be used to enable the wireless communication device 104 or 204 to determine a TCI state applied for a signal in a serving CC (e.g., CC-2) according to a TCI state pool in the serving CC (e.g., TCI state pool-2 404 in CC-2). “Mode-2” can be used to enable the wireless communication device 104 or 204 to determine a TCI state applied for a signal in a serving CC (e.g., CC-2) according to a TCI state pool in an reference CC (e.g., TCI state pool-1 402 in CC-1). Specifically, if the wireless communication device 104 or 204 is provided with a second parameter that is indicative of Mode-2, when the wireless communication device 104 or 204 receives a RRC signaling or MAC-CE signaling that is used to update the beam (e.g., as in Example-1 through Example-4) for CC-2, the wireless communication device 104 or 204 can only find the TCI state corresponding to the configured or activated TCI state IDs in TCI state pool-1 402 in CC-1, regardless of whether there is a TCI state pool in CC-2 and/or whether the configured or activated TCI state IDs are defined in the TCI state pool-2 404 (if it exists) in CC-2.

### Example 7

According to yet another example, assume that CC-1 is a primary cell (PCell) and CC-2 is a secondary cell (SCell). In a beam failure recovery (BFR) procedure, assume that the wireless communication device 104 or 204 is not provided with a beam failure detection reference signal (BFD-RS) set (this set can be called “q0”) by a RRC signaling in CC-2. In this case, the wireless communication device 104 or 204 can find the q0 in CC-2 according to a QCL-RS applied to PDCCH (or CORESET) in CC-2. The QCL-RS can be determined according to the TCI state that may be derived from the TCI state pool in CC-1. So, QCL-TypeA RS applied to PDCCH in CC-2 may be in CC-2, and QCL-TypeD RS applied to PDCCH in CC-2 may be in CC-1. But, RS in the q0 applied to CC-2 can generally required to be in the serving CC (e.g., CC-2). Considering that the QCL-TypeD RS is QCLed with the QCL-TypeA RS and the QCL-TypeD RS is not in CC-2, the wireless communication device 104 or 204 can use the QCL-TypeA RS as the RS in q0 applied to CC-2.

### Example 8

Similar to Example-7 above, at a given time instant, the wireless communication device 104 or 204 can find a q0 applied to CC-2. The QCL-TypeA RS and QCL-TypeD RS applied to PDCCH may be in CC-2. But, the QCL-TypeD RS is an aperiodic RS. Generally speaking, RS in the q0 applied to CC-2 can be required to be a periodic RS. Considering that the QCL-TypeD RS is QCLed with the QCL-TypeA RS and the QCL-TypeA RS (e.g., TRS) is generally a periodic RS, the wireless communication device 104 or 204 can use the QCL-TypeA RS as the RS in q0 applied to CC-2.

The various embodiments described above and in the claims can be implemented as computer code instructions that are executed by one or more processors of the wireless communication device (or UE) 104 or 204 and/or the wireless communication node 102 or 202. A computer-readable medium may store the computer code instructions.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used therein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
determining, by a wireless communication device, that a defined condition is met;
determining, by the wireless communication device responsive to the defined condition being met, a beam state to be applied to a signal in a first component carrier (CC) according to a beam state pool in a second CC; and
communicating, by the wireless communication device, the signal according to information associated with the beam state.

2. The method of claim 1, wherein the information associated with the beam state includes at least one of: a quasi-co location (QCL) assumption, a spatial relation, or a power control (PC) parameter.

3. The method of claim 1, wherein the signal comprises at least one of: a physical downlink shared channel (PDSCH), a physical downlink control channel (PDCCH), a physical uplink shared channel (PUSCH), a physical uplink control channel (PUCCH), a PUCCH group, a channel state information reference signal (CSI-RS), or a sounding reference signal (SRS).

4. The method of claim 1, comprising:
receiving, by the wireless communication device from a wireless communication node in the first CC, downlink control information (DCI) including a transmission configuration indicator (TCI) field that indicates an activated beam state in the second CC.

5. The method of claim 1, comprising:
receiving, by the wireless communication device from a wireless communication node, a control signaling that indicates an index of the second CC, the control signaling comprising at least one of: a radio access control (RRC) signaling, a medium access control control element (MAC CE) signaling, or a downlink control information (DCI) signaling; and
determining, by the wireless communication device, the second CC according to the index of the second CC.

6. The method of claim 1, comprising:
receiving, by the wireless communication device from a wireless communication node, a control signaling that indicates at least one of an index of the first CC or an index of a CC group including the first CC, the control signaling comprising at least one of: a radio access control (RRC) signaling, a medium access control control element (MAC CE) signaling, or a downlink control information (DCI) signaling; and
determining, by the wireless communication device, the first CC according to the index of the first CC or the index of the CC group including the first CC.

7. The method of claim 1, wherein the second CC and the first CC belong to a same CC group, and the method comprises:
determining, by the wireless communication device from the CC group, a CC with a configured beam state pool, as the second CC; or
determining, by the wireless communication device from the CC group, a CC that is a primary cell (PCell), as the second CC; or
determining, by the wireless communication device from the CC group, a CC with a lowest CC index or a highest CC index, as the second CC.

8. The method of claim 1, wherein determining that the defined condition is met comprises:
determining that the wireless communication device is not provided or configured with a beam state pool in the first CC.

9. The method of claim 1, wherein determining that the defined condition is met comprises:
determining, by the wireless communication device, that a beam state identifier (ID) configured by a radio resource control (RRC) signaling for the beam state applied to the signal, is not defined in a beam state pool in the first CC,
wherein a type of the signal includes at least one of periodic or aperiodic.

10. The method of claim 1, wherein determining that the defined condition is met comprises:
determining, by the wireless communication device, that a beam state identifier (ID) activated by a medium access control control element (MAC CE) signaling for the beam state to be applied to the signal, is not defined in a beam state pool in the first CC,
wherein a type of the signal includes at least one of: semi-persistent or aperiodic.

11. The method of claim 1, wherein determining that the defined condition is met comprises:
receiving, by the wireless communication device via radio resource control (RRC) signaling, a parameter to enable the wireless communication device to determine the beam state to be applied to the signal in the first CC according to the beam state pool in the second CC.

12. The method of claim 11, wherein the parameter indicates at least an index of the second CC, or
wherein if the wireless communication device is provided with the parameter, the wireless communication device does not expect that the wireless communication device is provided or configured with a beam state pool in the first CC.

13. The method of claim 1, wherein determining that the defined condition is met comprises:
receiving, by the wireless communication device via a signaling, a parameter to set the wireless communication device to operate in a mode 2, wherein:
in a mode 1, the wireless communication device is to determine the beam state to be applied to the signal in the first CC according to a beam state pool in the first CC; and
in the mode 2, the wireless communication device is to determine the beam state to be applied to the signal in the first CC according to the beam state pool in the second CC.

14. The method of claim 13, wherein the parameter includes at least an index of the second CC, or
wherein if the wireless communication device receives a parameter to set the wireless communication device to operate in the mode 2, no beam state pool is expected to be configured in the first CC.

15. The method of claim 1, comprising:
reporting, by the wireless communication device to a wireless communication node, a capability of the wireless communication device to support at least one of:
the wireless communication device is to determine the beam state to be applied to the signal in the first CC according to the beam state pool in the second CC;
in a mode 1, the wireless communication device is to determine the beam state to be applied to the signal in the first CC according to a beam state pool in the first CC; or
in a mode 2, the wireless communication device is to determine the beam state to be applied to the signal in the first CC according to the beam state pool in the second CC.

16. The method of claim 2, wherein:
the QCL assumption includes a first QCL type and a second QCL type, wherein the first QCL type includes at least one of QCL TypeA, QCL TypeB or QCL TypeC, and the second QCL type includes at least QCL TypeD,
a RS of the first QCL type is located in the first CC and is indicated by a RS resource identifier (ID) in the beam state, and a RS of the second QCL type is located in the first CC or the second CC and is indicated by a RS resource ID in the beam state, and
the RS of the first QCL type is quasi co-located with the RS of the second QCL type.

17. A method comprising:
communicating, by a wireless communication node with a wireless communication device, a signal in a first component carrier (CC) according to information associated with a beam state,
wherein a defined condition is determined by the wireless communication device to be met, and responsive to the defined condition being met, the beam state is determined by the wireless communication device according to a beam state pool in a second CC.

18. A wireless communication device, comprising:
at least one processor configured to:
determine that a defined condition is met;
determine, responsive to the defined condition being met, a beam state to be applied to a signal in a first component carrier (CC) according to a beam state pool in a second CC; and
communicate via a transceiver, the signal according to information associated with the beam state.

19. A wireless communication node, comprising:
at least one processor configured to:
communicate, via a transceiver with a wireless communication device, a signal in a first component carrier (CC) according to information associated with a beam state,
wherein a defined condition is determined by the wireless communication device to be met, and responsive to the defined condition being met, the beam state is determined by the wireless communication device according to a beam state pool in a second CC.
